(19) United States
(12) Patent Application Publication
(10) Pub. No.: US 2024/0262189 A1
(43) Pub. Date: Aug. 8, 2024

(54) Device for Controlling an Individual Wheel Drive in Electrified Two-Axle Motor Vehicles

(71) Applicant: Bayerische Motoren Werke Aktiengesellschaft, Muenchen (DE)

(72) Inventor: Alexander HIERETH, Muenchen (DE)

(21) Appl. No.: 18/564,681

(22) PCT Filed: Jul. 11, 2022
(86) PCT No.: PCT/EP2022/069222

§ 371 Date: Nov. 28, 2023

(30) Foreign Application Priority Data
Aug. 9, 2021 (DE) 10 2021 120 594.8

(51) Int. Cl. B60K 17/04; B60K 7/00; B60K 17/02; B60K 23/04

(52) U.S. Cl. CPC B60K 17/043; B60K 7/0007; B60K 17/02; B60K 23/04; B60K 2023/043

(57) ABSTRACT

An apparatus for controlling an individual wheel drive in a two-axle motor vehicle having at least one electrified vehicle axle on which an electric drive motor is associated with each wheel is provided. The apparatus includes an electronic controller and a coupling which can be controlled by the electronic controller between the electric drive motors, wherein the electronic controller and the coupling are configured in such a way that (i) given at least one first specified condition in a first actuating mode, only one defined electric drive motor drives both wheels, with the other electric drive motor being stopped, and (ii) given at least one second specified condition in a second actuating mode, both electric drive motors drive one wheel each, separately from one another.

### BACKGROUND AND SUMMARY

The invention relates to a device for controlling an individual wheel drive in a two-axle motor vehicle having at least one electrified axle on which an electric drive motor is associated with each wheel.

Individual wheel drives are increasingly being used in vehicles that have at least one electrically driven axle. Among the advantages of the individual wheel drive is the possibility of implementing wheel-specific distribution of the drive torque (e.g., for so-called “torque vectoring”). Dispensing with a differential gear means that the torque has to be distributed equally or with a selective difference between the two wheels of the axle that has an electric individual wheel drive, depending on the desired longitudinal and lateral acceleration of the vehicle.

This flexibility also entails a high demand on the accuracy of the output torque of two completely or partially independent electric drives or drive motors. Excessive deviation of the torques from the respective target value can have a negative effect on the driving dynamics. The driver would have to compensate by significant counter-steering when driving straight ahead. Above a certain threshold, the driving behavior of the vehicle is not acceptable. DE 10 2018 213 468 A1, for example, addresses this problem.

The invention is based on the object of improving control of an individual wheel drive, in particular in respect of a reduced energy requirement and at the same time in respect of increased functional reliability.

According to the invention, this object is achieved by the features of the independent claims, while the dependent claims specify preferred developments of the invention.

The invention relates to a device for controlling an individual wheel drive in a two-axle motor vehicle having at least one electrified vehicle axle on which an electric drive motor is associated with each wheel, having an electronic control unit and having a coupling unit which can be adjusted by the control unit between the electric drive motors, the control unit and the coupling unit being configured in such a way that
given at least one first specified condition in a first actuating mode (mode 1), only one defined electric drive motor drives both wheels, the other electric drive motor being stopped, and
given at least one second specified condition in a second actuating mode (mode 2), both electric drive motors drive one wheel each, separately from one another.

The second electric drive motor is therefore the main electric drive motor, which is activated in both actuating modes.

The coupling unit can be designed, for example, by sliding sleeves, magnetic couplings or claw couplings. However, the use of sliding sleeves is particularly advantageous on account of the lower expenditure on construction.

For mode 1, the coupling unit preferably comprises two sliding sleeves, a first sliding sleeve, in the first actuating mode, decoupling a first electric drive motor from the first drive shaft, which is associated with it, and a second sliding sleeve, in the first actuating mode, coupling the second electric drive motor to this first drive shaft.

For mode 2, the coupling unit preferably comprises two sliding sleeves, the/a first sliding sleeve, in the second actuating mode, coupling the first electric drive motor to the first drive shaft, which is associated with it, and the/a second sliding sleeve, in the second actuating mode, coupling the second electric drive motor to the second drive shaft, which is associated with it.

Here, the second sliding sleeve, in both actuating modes (mode 1, mode 2), is preferably connected to the bevel gear of a differential on the second drive shaft or output shaft.

The invention is based on the following considerations:

Background of the invention: increased requirements in multiple-motor concepts, in particular in respect of an improvement in efficiency under low loads.

Prior art: various manufacturers already use decoupling elements which allow decoupling of electric machines in vehicles. However, this always involves decoupling entire vehicle axles. For example, the rear axle can be decoupled and the front axle can be specified as the (only) drive axle.

Technical problem: with the known technical solutions, in particular in electric vehicles with an all-wheel drive, one vehicle axle is always decoupled in favor of another/the other vehicle axle. In the case of multiple-motor concepts with, for example, two electric machines on the rear axle, the problem then arises that, when the (entire) rear axle is decoupled, driving has to be performed only with the front axle in order to achieve efficiency objectives. The actually desired rear wheel drive, which is more favorable in terms of driving dynamics, would therefore not be possible in the case of an efficiency operating strategy of this kind.

Basic principle of the invention: using the invention, it is possible to temporarily, in particular on the rear axle, switch off an electric motor (short for electric drive motor or electric machine) and to drive both rear wheels using the other electric motor via a known differential. This provides the advantage that this one electric motor can be operated at a better characteristic map point and therefore efficiency objectives can be achieved more effectively, a rear wheel drive at the same time in principle being able to be at least partly maintained. However, the device according to the invention can also be provided in addition to or as an alternative to a front axle.

An exemplary embodiment of the invention is illustrated in the drawing and will be described in more detail below. In the drawings:

### BRIEF DESCRIPTION OF THE DRAWINGS

FIG. 1 shows a schematic illustration of an overview of the essential components of the invention in a first mode, and

FIG. 2 shows a schematic illustration of an overview of the essential components of the invention in a second mode.

### DETAILED DESCRIPTION OF THE DRAWINGS

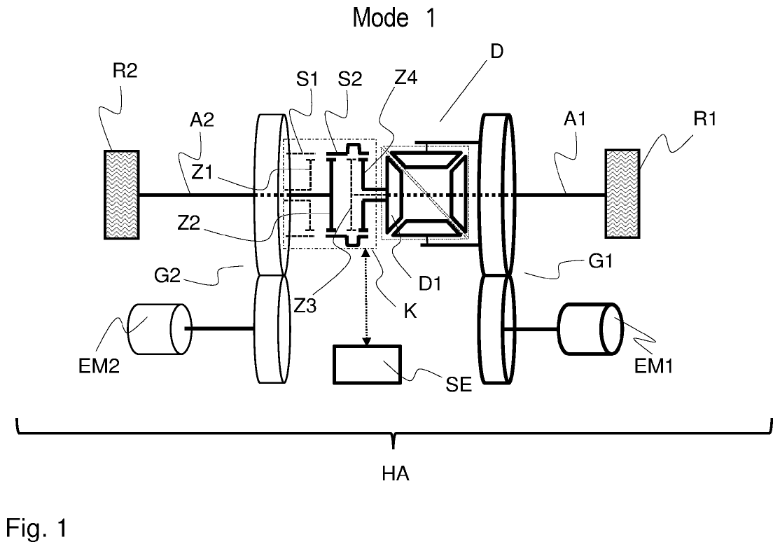

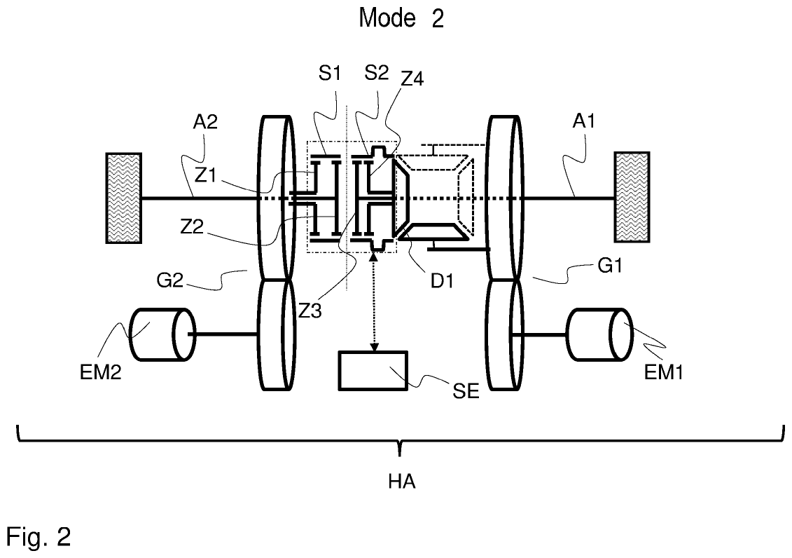

FIG. 1 shows a mode 1, and FIG. 2 shows a mode 2.

In principle, both electric motors EM1 and EM2 are used in mode 2 according to FIG. 2. On the side of one electric motor EM2 (e.g., on the left-hand side of a rear axle HA), the (last) gear Z1 of the transmission G2 is connected to the output shaft A2 via a gear Z2 by a first (e.g., left-hand) sliding sleeve S1. On the side of the other electric motor EM1 (e.g., on the right-hand side of a rear axle HA), the (here) left-hand outer bevel gear D1 of a differential D is connected to the other output shaft A1 by a second (here right-hand) sliding sleeve S2 via the gears Z3 and Z4. Therefore, the differential is rigid and the electric motor EM1 is directly connected to the right-hand output shaft A1.

In mode 1 according to FIG. 1, the electric motor EM2 is decoupled from the drive or from the output shaft A2 and can be stopped by means of the first sliding sleeve S1. The connection in the differential D is canceled and the left-hand bevel gear D1 is coupled to the left-hand output shaft A2 by means of the second sliding sleeve S2.

Identical components are provided with the same reference signs in FIG. 1 and FIG. 2. Both Figures show the identical components once in mode 1 and once in mode 2. Therefore, both Figures show the control according to the invention of an individual wheel drive in a two-axle motor vehicle having at least one electrified vehicle axle on which an electric drive motor EM1 and EM2 is associated with each wheel R1 and R2. The Figures further show an electronic control unit SE and a coupling unit K which can be adjusted between the electric drive motors EM1 and EM2 by the control unit SE, the control unit SE and the coupling unit K being configured to implement two modes 1 and 2. In mode 1, the coupling unit K, which comprises two selection sleeves S1 and S2 in particular, is designed, in particular also by corresponding programming of the control unit SE, in such a way that, given at least one first specified condition, only one defined electric drive motor, here EM1, drives both wheels R1 and R2, the other electric drive motor, here EM2, being stopped. In mode 2, the coupling unit K, which comprises two selection sleeves S1 and S2 in particular, is designed, in particular by corresponding programming of the control unit SE, in such a way that, for at least one second specified condition, the two electric drive motors EM1 and EM2 drive one wheel R1 and R2 each, separately from one another.

Here, in mode 1, the first electric drive motor EM2 is decoupled from the first drive shaft A2, which is associated with it, by means of the first sliding sleeve S1, which is adjusted to a first actuating position. In mode 1, the second electric drive motor EM1 is coupled to this first drive shaft A2 by means of the second sliding sleeve S2, which is likewise adjusted to a first actuating position, (FIG. 1).

In mode 2, the first sliding sleeve S1 is adjusted to a second actuating position in such a way that the first electric drive motor EM2 is coupled to the first drive shaft A2, which is associated with it. The second sliding sleeve S2 is likewise adjusted to a second actuating position by way of which the second electric drive motor EM1 is coupled to the second drive shaft A1, which is associated with it (FIG. 2).

The second sliding sleeve S2 is connected to the bevel gear D1 of the differential D, which is associated with the second drive shaft A1, in both actuating modes (mode 1, mode 2).

1.-6. (canceled)

7. An apparatus for controlling an individual wheel drive in a two-axle motor vehicle having at least one electrified vehicle axle on which an electric drive motor is associated with each wheel, the apparatus comprising:
an electronic controller; and
a coupling which can be adjusted by the electronic controller between the electric drive motors;
wherein the electronic controller and the coupling are configured in such a way that
given at least one first specified condition in a first actuating mode, only a first electric drive motor of the electric drive motors drives both wheels, and a second electric drive motor of the electric drive motors is stopped, and
given at least one second specified condition in a second actuating mode, both of the electric drive motors drive one wheel each, separately from one another.

8. The apparatus as claimed in claim 7, wherein
the coupling comprises a first sliding sleeve and a second sliding sleeve,
the first sliding sleeve, in the first actuating mode, being configured to decouple the second electric drive motor from the first drive shaft, which is associated with the second electric drive motor, and
the second sliding sleeve, in the first actuating mode, being configured to couple the first electric drive motor to the first drive shaft.

9. The apparatus as claimed in claim 7, wherein
the coupling comprises a first sliding sleeve and a second sliding sleeve,
the first sliding sleeve, in the second actuating mode, being configured to couple the first electric drive motor to the first drive shaft, which is associated with the first electric drive motor, and
the second sliding sleeve, in the second actuating mode, being configured to couple the second electric drive motor to the second drive shaft, which is associated with the second electric drive motor.

10. The apparatus as claimed in claim 8, wherein the second sliding sleeve, in both actuating modes, is connected to a bevel gear of a differential on the second drive shaft.

11. The apparatus as claimed in claim 9, wherein the second sliding sleeve, in both actuating modes, is connected to a bevel gear of a differential on the second drive shaft.

12. The apparatus as claimed in claim 7, wherein the at least one first specified condition includes a power requirement below a first defined threshold.

13. The apparatus as claimed in claim 8, wherein the at least one first specified condition includes a power requirement below a first defined threshold.

14. The apparatus as claimed in claim 9, wherein the at least one first specified condition includes a power requirement below a first defined threshold.

15. The apparatus as claimed in claim 10, wherein the at least one first specified condition includes a power requirement below a first defined threshold.

16. The apparatus as claimed in claim 11, wherein the at least one first specified condition includes a power requirement below a first defined threshold.

17. The apparatus as claimed in claim 7, wherein the at least one second specified condition includes a power requirement above a second defined threshold.

18. The apparatus as claimed in claim 8, wherein the at least one second specified condition includes a power requirement above a second defined threshold.

19. The apparatus as claimed in claim 9, wherein the at least one second specified condition includes a power requirement above a second defined threshold.

20. The apparatus as claimed in claim 10, wherein the at least one second specified condition includes a power requirement above a second defined threshold.

21. The apparatus as claimed in claim 11, wherein the at least one second specified condition includes a power requirement above a second defined threshold.

22. The apparatus as claimed in claim 12, wherein the at least one second specified condition includes a power requirement above a second defined threshold.
